(19) United States
(12) Patent Application Publication
(10) Pub. No.: US 2017/0172344 A1
(43) Pub. Date: Jun. 22, 2017

(54) OMELET LID

(71) Applicant: Maria Romano, Arlington, MA (US)

(72) Inventor: Maria Romano, Arlington, MA (US)

(21) Appl. No.: 14/970,830

(22) Filed: Dec. 16, 2015

(51) Int. Cl. A47J 37/10

(52) U.S. Cl. CPC A47J 37/101

(57) ABSTRACT

An omelet lid for a frying pan comprising: a top surface; a handle attached to the top surface; an inside surface, where said inside surface is flat to receive an omelet; and a ridge on the inside surface, where the ridge secures the lid to a frying pan during use. The omelet lid preferably includes a cutout along the perimeter of the lid. The omelet lid used with a cooking pan creates a system for omelet preparation.

### BACKGROUND OF THE INVENTION

Field of Invention

The present invention relates to a specialized omelet lid that ensures an easy turning and flipping of the omelet while cooking.

Description of Related Art

Many individuals enjoy preparing an omelet as a breakfast dish. Normally an omelet prepared in a flat skillet or pan and requires turning or flipping of the omelet to ensure even cooking on both sides of the omelet. However some individuals have difficulties in flipping larger omelets without spilling or wasting food during the process thereof. A larger omelet may be difficult to handle with a spatula and using another utensil or a plate also is difficult to ensure the easy turning of the omelet is accomplished. As a result, it would be advantageous to have a lid, which could easily receive the omelet for flipping the omelet during cooking. Most lids for pans or skillets are concave. As a result attempting to use a concave lid would not be effective in turning or flipping an omelet during cooking.

### SUMMARY OF THE INVENTION

The present invention relates to an omelet lid for a frying pan comprising: a top surface; a handle attached to the top surface; an inside surface, where said inside surface is flat to receive an omelet; and a ridge on the inside surface, where the ridge secures the lid to a frying pan during use. The omelet lid preferably includes a cutout along the perimeter of the lid. The omelet lid used with a cooking pan creates a system for omelet preparation.

### BRIEF DESCRIPTION OF DRAWING

FIG. 1 depicts a top view of an omelet lid in accordance with the present invention.

FIG. 2 depicts a side view of the omelet lid in accordance with the present invention.

FIG. 3 depicts the underside of the omelet lid in accordance with the present invention.

FIG. 4 depicts the omelet lid according to the present invention used with a skillet or frying pan.

### DETAILED DESCRIPTION

The present invention relates to an omelet lid specifically designed for use with a frying pan to assist the user in flipping and cooking of an omelet. The omelet lid according to present invention is flat with a rim that locks the lid into place onto a frying pan. As such the user may easily turn the pan and flip the omelet onto the lid in order to flip the omelet onto a reverse side for cooking in the pan. After the user flips the omelet onto the lid, the omelet may safely slide, raw side down, back into the pan to complete cooking. The pan further includes a top handle that allows the user to hold the lid during the flipping process and easily preserve the contents of the omelet in a stationary position while flipping. A small cutout is provided on the perimeter of the lid to ensure that the lid fits securely onto the frying pan.

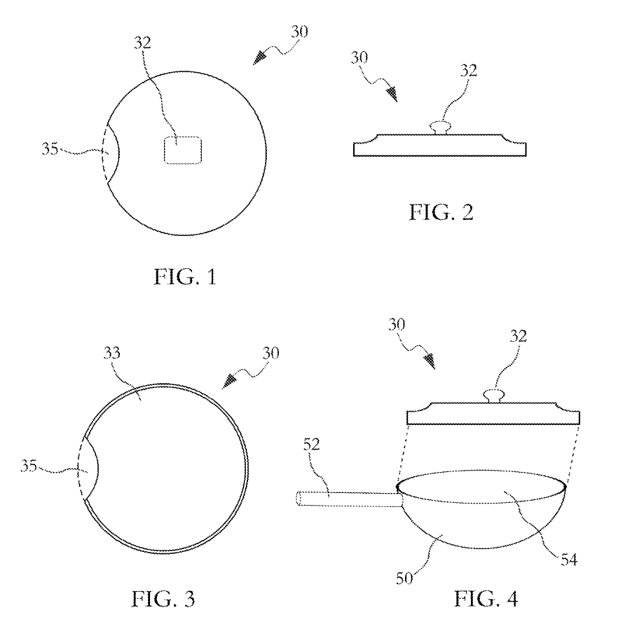

In reference to FIG. 1, a top view of an omelet lid 30 in accordance with the present invention is depicted. The top lid 30 includes a handle 32 and a small cutout 35 along the perimeter thereof. This lid 30 fits securely onto a frying pan and is substantially flat on the inside surface as shown in FIG. 3. FIG. 3 shows the lid 30 and the inside surface 33 with cutout 35 provided along with the perimeter of the lid 30. A rim is provided on the inside surface 33 to secure the lid onto the frying pan used in conjunction with the lid 30.

FIG. 2 depicts a side view of the lid 30 giving a more detailed view of the handle 32 and the overall dimensions of the outer surface of the lid 30. The lid 30 as shown is used in conjunction with a frying pan 50 in FIG. 4. The lid 30 fits securely onto the frying pan 52 attaching thereto during cooking. A handle 52 of the frying pan 50 is used to turn and flip the omelet enclosing it within the frying pan 50 onto the flat surface 33 of the lid 30. This configuration allows the individual to easily flip and secure the contents of the omelet to complete preparation thereof in the frying pan 50.

What is claimed is:

1. A omelet lid for a frying pan comprising:
a. a top surface;
b. a handle attached to the top surface;
c. an inside surface, where said inside surface is flat to receive an omelet; and
d. a ridge on the inside surface, where the ridge secures the lid to a frying pan during use.

2. The omelet lid according to claim 1, where the lid includes a cutout along the perimeter of the lid.

3. A system for omelet preparation comprising:
a. a cooking pan;
b. a lid, where the lid includes a handle on a top surface and a flat inside surface; and
c. a ridge on the inside surface, where the ridge secures the lid to the cooking pan and said inside surface is adapted to receive an omelet for flipping purposes.
